(19) United States
(12) Patent Application Publication
(10) Pub. No.: US 2024/0194064 A1
(43) Pub. Date: Jun. 13, 2024

(54) LIGHTING SYSTEM FOR ROAD CROSSING, MAINLY FOR PEDESTRIAN CROSSWALKS, METHOD OF LIGHTING

(71) Applicant: Filip Kovalovsky, Bratislava (SK)

(72) Inventor: Filip Kovalovsky, Bratislava (SK)

(21) Appl. No.: 18/554,052

(22) PCT Filed: Apr. 7, 2022
(86) PCT No.: PCT/IB2022/053256

§ 371 Date: Oct. 5, 2023

(30) Foreign Application Priority Data
Apr. 7, 2021 (SK) PUV 50029-2021

(51) Int. Cl. G08G 1/08; F21S 6/00; F21S 10/02; F21W 111/023; H05B 47/125; H05B 47/18; H05B 47/19

(52) U.S. Cl. CPC G08G 1/08; F21S 6/006; F21S 10/02; H05B 47/125; H05B 47/183; H05B 47/19; F21W 2111/023

(57) ABSTRACT

The system includes at least one light projector designed for focused projection of the image onto the surface of the road crossing. The light projector is connected with the control unit and is designed for projection of various images onto the persons and road in the place of crossing. The image from the light projector includes circles, polygons, strips, squares, rectangles, and combinations thereof, which are separated by surfaces of different color or different level of illumination. There are sharp, contrasting boundaries between individual, usually repeating elements of the image. In the preferable arrangement the system includes at least one sensor of the physical values of the environment connected to the control unit and eventually a camera and/or vehicle speed sensor and/or sensor of physiological values of the persons in the vicinity of the road crossing, too. The system can include a speaker connected to the control unit.

### CROSS REFERENCE TO RELATED APPLICATION

This application is a national stage entry of PCT/IB2022/053256 filed Apr. 7, 2022, under the International Convention and claiming priority over Slovakia Patent Application No. PUV 50029-2021 filed Apr. 7, 2021.

### TECHNICAL FIELD

The invention concerns the system which illuminates the space of crossings in traffic, mainly pedestrian crosswalks, eventually cyclist crossings. The system highlights the presence of the person on the crossing, whereby it can take into account multiple individual data sense in the vicinity of the crossing. The invention also discloses an adaptive method of lighting, which prevents the blinding of the drivers by light while it ensures high intensity of lighting.

### PRIOR STATE OF THE ART

In order to decrease the number of accidents at pedestrian crosswalks or cyclist crossings in frequented places in villages, towns and cities, a common street lighting is placed by the crossings so that the pedestrian or the cyclist is visible during the dark before he or she enters the road.

Adaptive systems of street lighting for the pedestrians crosswalks which sense the presence of the pedestrians and subsequently warn the drivers by light signal to the presence of the pedestrian, and pursuant to the light situation they also turn on the illumination of the road in place of the crossing, are known. An adaptive illumination of the pedestrian crosswalk is disclosed in CN210507195U, ES2724048, KR101655730B1. The presence of the people in the vicinity of the crosswalk is determined by movement sensors which record the approach of a person to the crosswalk. Pursuant to the angle of view and sensibility of the respective sensor the assessment is set for the person's figure in such a way that there is not mistaken detection. Presence of the pedestrians is also determined by cameras analyzing the images pursuant to CN110321823A. Such assessment is demanding from the software and hardware point of view and the system is complicated.

The dimming or turning off of light at the crossing in case the system assesses that there are no persons in the vicinity of the crossing has several reasons. Inactive crossing should not blind the drivers who drive on the road; the system should be energetically effective and shall not produce light smog.

The illumination of the space of the crossing is usually realized by LED lighting which is stably attached on the pole on the sidewalk by the crossing's mouth. In order to increase the uniformity of the lighting, booms or beams are used, thanks to which the LED lighting body gets to the position above the crossing, which achieves a more advantageous position. The boom or beam must be placed sufficiently high so that it does not limit the height profile of the road.

Such solution of the lighting is therefore desired and not known, which will further emphasize the presence of the pedestrians or cyclists. The new solution shall not require complicated hardware amendments on the crossing itself.

### SUMMARY OF THE INVENTION

The abovementioned deficiencies are significantly remedied by the lighting system for road crossings, mainly pedestrian crosswalks, which includes at least one lighting body and sensors of the presence of persons on both sides of the crossing, whereby the sensors of the presence of the persons are connected with the control of the lighting body pursuant to this invention which essence lies in the fact that the lighting body is formed by the light projector whose light field is directed onto the crossing, whereby the light projector is designed for projection of various images onto the persons and the road in the place of crossing.

The term “light projector” in this file denotes a projection device, a projection machine, a film projector, a cinema projector, a video projector, a projector, or any device capable of projecting images onto the road surface, respectively. It is a kind of projection device which has a source of light and optical elements for the reproduction of image. During projecting the images are displayed on the body or the clothing of the persons on the crossing, too. This significantly increases their visibility so that even heedless driver, or driver with impaired perceptiveness, will notice the images with moving elements on the persons. Preferably at least two light projector or multiple light projectors pursuant to the number of lanes are used, but in principle a solution with a single light projector for the whole surface of the crossing is possible. The light projectors can be attached on the poles at the side of the road, they can be placed on a crossbeam that crosses above the road or crossing, or they can be placed in another suitable place, for example on a building near the crossing, respectively.

It is also preferably of the sensor of the vehicle approaching the crossing is part of the system, or multiple sensors, respectively, which detects the vehicles in both directions, eventually in multiple lanes, whereby this sensor of the vehicle or multiple sensors of the vehicle are connected with the control of the light projector in such a way that at least on part of the projected surface the intensity of the lighting or intensity of the lighting in the moment the vehicle is in the projection field of the light projector, respectively, can be altered. The light projectors are capable of a very intensive projection lighting where the projected images have very sharp edges. This is preferable in order to increase the emphasis of the overall effect in form of clear warning to the driver approaching the crossing. Such arrangement, however, can blind the driver when the vehicle is in the illuminated field of the light projector. Such a phenomenon is short term—pursuant to the speed of the vehicle it can last for tenths of seconds—but it can distract the driver or blind him by direct or reflected light. Because of this it is preferable if the system is equipped by means for detection of the vehicle, whereby the light projector is controlled in such a way that during the time of illumination of the vehicle at least respective part of the projected field is darkened. Thanks to this the remaining part of the projected field, or whole field except for the period of crossing of the vehicle, is illuminated very intensively.

Various technical means can be used for limitation the intensity of the projected surface. Mechanical dampers, shades or blinds can be used, which blind the part of the projected field, or an electronically controlled darkening filter on LCD basis can be used, or the shape of the projected image is simply modified in the electronically controlled light projector.

The sensor of the approaching vehicle can have a form of a contactless sensor which measures the diminishing distance of the body of the vehicle in the respective lane, or it can be a series of inductive sensors on the road, or it can be a camera which senses the image with the respective lane and it identifies a vehicle in the image data. The detection by means of camera allows not only to identify the vehicle but also its speed, thanks to which it can calculate the time when the vehicle will be at the place of crossing; moreover, the image data can be at least roughly used to delimit the space of front windshield which can have various sizes and slopes. The limitation of the intensity of the lighting of the projection field can be subsequently adapted to the detected surface and position of the front windshield, whereby approximately the vertical windshield of the bus can be differentiated from the sloped windshield of the sport car. Similarly, a helmet of the motorcyclist can be detected and so on. The advantage of the use of cameras for detection of the approaching vehicles is also the possibility of inclusion of cameras into the wider system of traffic safety, for example for detection of traffic offenses and so on. When processing the image data, various algorithms can be later installed, too, with recognition elements with artificial intelligence.

In the simplified arrangement the sensor of the approaching vehicle can be produced as induction sensor where the loop of the sensor is on the road before the crossing or close to the crossing and the activation of the sensor causes the darkening of that part of the crossing which has activated the sensor.

This arrangement with the sensors of the approaching vehicle and with means for at least partial diminishing of intensity of the illumination of the light projector for at least part of the projected field allows to use the new method of control of the crossings, mainly crosswalks, according to this invention which essence lies in the fact that it senses the presence of the persons on both sides of the crossing, and during the presence of the person by the crossing it illuminates the crossing, whereby it, at the same time, determines the approach of the vehicle to the crossing, and then it subsequently diminishes the intensity of illumination of crossing by the light projector for at least part of the crossing's surface where the vehicle is present.

The diminishing of the intensity of lighting is preferably realized on the surface which corresponds to the actual position of the windshield of the vehicle and/or the head of the driver. The diminishing of intensity of illumination can take place gradually or in leaps, whereby subsequently the restoration of the intensity is in preferable arrangement gradual. It still holds that the light projector projects various images onto the persons and the road in place of crossing.

It is preferable if the projected images include repeated graphical elements with clear and sharply defined boundaries of the objects. The elements can be circles, polygons, strips, squares, rectangles, and combinations thereof, which are separated by surfaces of different color, or by surface without illumination, which produces sufficient contrast with larger amount of clear color transitions between the neighboring elements in the image. The projected image can cover the sidewalk near the crosswalk or similar surface from which pedestrian enters the crosswalk. The pedestrian during the movement walks among individual light boundaries of the objects, which produces a changing visual impression on his body or clothing, respectively, and it does so even in case the projected image is at that moment static. The use of light projector with static image or with possibility to select multiple static images, respectively, is preferable from the point of view of simplicity and low costs. In order to produce a static image a simple optical template or filter can be used. The change of one static image for another static image can be realized by mechanical replacement of the optical template or filter, preferably the movement or replacement of the optical template or optical filter will be ensured electromechanically or mechanically with electronic control, respectively. Even with use of such simple method one can achieve the movement or rotation of the image by moving the template or the filter.

The image projected by the light projector can include writings and/or pictograms, too, which will be comprehensible for the traffic participants. Individual images can be cropped or shaded as needed.

The advantage of the light projector lies also in the direction of the light flow by means of optical elements into a focused flow, thanks to which the person on the crossing is illuminated in such a way that in the field of vision of the driver it is viewed as central visual elements in the same way the actor is illuminated on the stage. The light projector can use optical system including mirrors or lenses and so on, for focusing of the flow. In order to achieve increased contrast of the image one can use standard mechanical light projector in case of which the color and image is determined by choice of optical templates and filters. A halogen bulb, gas discharge lamp or LED light source can be used, which have high luminosity. For more advanced control of the image one can use video projector which displays images generated pursuant to graphic data from the control unit. The term “video projector” in this filed denotes any device for projection of image information pursuant to computer data. The video projectors insofar do not offer sufficient contrast and luminosity at prices of mechanic light projectors, but they can be used for the purposes of increased flexibility of the projected images. The proposed invention offers two main synergetic advantages resulting from the use of light projector—that is, emphatic illumination of the person on the crossing and production of images with contrast transitions which the crossing person crosses and thereby produces a changing visual perception in the visual field of the driver.

These two main advantages are further emphasized in the system pursuant to this invention, when further sensors for assessment of the actual situation are used aside from common sensors of the presence of the person in the vicinity of the crossing. Pursuant to the more precise assessment of the situation the form, color or type of the image projected onto the surface of the road in the place of crossing can be altered. These states and factors where hitherto not assessed in the known adaptive lighting devices, since there has not been a meaningful use for them and illumination only had two states—on or off. However, proposed invention allows displaying whole scale of the states by means of different color and by means of various shapes. It is therefore preferably if the system according to this invention includes at least one of these sensors:
visible light spectrum sensor,
temperature and/or humidity and/or air pressure sensor,
air flow speed sensor,
dew point sensor,
acoustic sensor, noise level sensor,
pollution sensor, or sensor of the amount of solid and/or dust particles in the air in the environment, respectively,
CO2, CO, NO2, H2S, formaldehyde, SO2, O3, NO and other gases composition sensor,
volatile organic compounds (VOC) concentration sensor, for example of isobutane, butane, alcohol,
an invisible spectrum intensity sensor, such as UV radiation, infrared light, magnetic field sensor,
radar,
position sensor and speed sensor of vehicles approaching the passage.

These sensors are connected with the control unit which assesses the received data and pursuant to set algorithm controls the light projector. Pursuant to the amount of visible light it sets the brightness of the light flow from the light projector. By sensing physical values of the environment such as temperature, pressure, air flow speed, it assesses the risks related to the vehicle braking, or eventually risks related to different behavior of the pedestrians.

Sensing other physical values of the environment can gradually produce a statistical image of the common behavior of the pedestrians in different parts of the day or week, and the determined behavioral patterns can be reflected in the control of the light projector. Because of this it is preferable if the control unit has open structure ready for connection of various data interfaces so that after the installation of the system in the basic version it can be extended by further sensors or peripherals.

A speaker connected with the control unit can be part of the system, too, where the speaker serves the purpose of warning the traffic participants. For example, if the system assesses that the vehicle approaching the crossing is not slowing down despite the presence of the pedestrian at the mouth of the crossing, it can issue sound signal to the pedestrian to pay attention and not enter the crossing. If system pursuant to the image data assesses the presence of the pedestrian as a visually impaired person, it can by sound signals support such a person in safe crossing of the road.

In the extended version the system can also involve a wireless communication with the vehicles and other elements or other traffic participants. For example, the system can react to the approaching vehicle with priority driving rights in such a way that it will send a signal and the system according to this invention will alert the pedestrian with color projection or through the speaker to the approaching ambulance or fire truck.

The system can also include a contactless sensing of the physiological functions of the pedestrians such as sensing of the heartbeat or the blood pressure, or it can communicate with the personal devices of the pedestrians such as sporting bracelets, watches and so on, which measure such biophysical values, whereby the gathered values can be used for control of the system.

The system according to the proposed invention can be designed for communication with and control from the superordinate control center. Such communication will be preferably two-way and the superordinate control center can gather and assess local data as well as statistical data concerning the behavior of the pedestrians and other traffic participants at the respective crossing. The statistical data can serve other purposes, too, for example the purposes of urban planning and so on.

The system can also be equipped by the camera or multiple cameras, whereby the image can be stored in time loops and/or it can be processed by means of objects recognition and prediction of their likely behavior, preferably by use of AI learning algorithms. Such conceived assessment can, after sufficient gathering of raw data, provide an overview of the reactions of the participants to various images, colors and sound signals and pursuant to these reactions the system can adapt in order to increase the safety of the traffic participants.

The system according to this invention can therefore include a simple connection of light projector and sensors of pedestrians' presence where the light projector is activated pursuant to time schedule so it takes into account the sunrise and sunset for the given locality with respective latitude (according to the declination of the Sun). Usually, the system will also include a sensor of intensity of the visible light so that it can better adapt to local conditions and respective microclimate. In the whole spectrum of other possibilities the system can be equipped by series of abovementioned sensors where the system is capable of taking into account, during the control of the light projector, other local conditions and actual state and position of pedestrians.

An important feature of the invention is the control unit to which the light projector, the sensors of the presence of the persons and eventually further sensors are connected. A communication module can be connected to the control unit, which can have web interface using Ethernet and/or GSM/GPRS and/or WiFi. Output network interface of the control unit will in preferable arrangement be connected to the Internet network and each unit will have its own IP address. This allows it to communicate at distance from any place which has connection to the Internet.

In the vicinity the system can be equipped by display and/or control element which will be, for example, locked in the box, and which could be approached by the maintenance technician. The display and/or control elements produces a graphic interface for the visualization of the data and statuses of the system, for the configuration of the system, and for the display of various statuses as well as setting parameters or direct manual control of the light projector.

Thanks to the configuration of the control unit the system can send the gathered values to the superordinate system autonomously or by order. The superordinate system can be a traffic control or traffic monitoring center or cloud or similar element or system. A larger village, town or city can have their own processing of multiple systems on the crossings. The supply of data concerning the situations on the crossings can be open to other subjects, too, for example, to respective traffic authority, to rescue services, to firefighters and so on.

Since in multiple villages, towns and cities the adaptive lighting of the crossings is connected to the public lighting, it is preferable if the communication routes are formed by the weak current cables alongside the cables and wires of the public lighting, wireless communication or PLC (Power Line Communication) modules, or their combination. In case of weak current cables the independent information cables are produced alongside the power supply cables; preferably DALI (IEC 6929 standard) bus can be used. In case of wireless communication some of the commercially available technologies is used, whereby one can use method where master controls multiple slave elements, or mesh RF network method. In case of PLC one can use existing wires and cables into which the signals are modulated. The advantage of PLC is that it works with reliable metallic wires and cables of the public lighting and it does not need to mount its own information cables.

With PLC platform the PLC master module will connected to the control unit, whereby this module ensures control and communication. PLC master module can have a complete three-phase operation. From the point of view of simple installation it is preferable if the unit has a body in the shape of multiple circuit breaker with an attachment element on DIN rail pursuant, for example to standard CSN EN 60715. Thanks to this the control unit can be simply attached into distribution boxes of any producer.

In the preferable arrangement the memory for storing raw data and crossing status statistics is part of the control unit.

The control unit and preferably other elements of the system can be integrated in the common box of the light projector which produces a compact device with simple installation. The integration of multiple elements of the system into a single body simplifies the demands for covering and resilience of the individual elements.

The advantages of the proposed invention are: increased safety on the crossings in traffic, high flexibility of the system, and possibility of automated gathering of raw data which include reactions of the traffic participants, which can be used for further optimization.

### BRIEF DESCRIPTION OF DRAWINGS

Invention is further disclosed in drawings 1 to 12. The depicted images are only examples of projected graphics and the varying color of the images is not depicted. The depicted arrangement and placement of the light projector and sensors is for illustration purposes only and cannot be interpreted as limiting the scope of protection.

FIG. 1 shows a system in ground plan with a single light projector and two sensors without the presence of pedestrians.

FIG. 2 shows the system of FIG. 1 with a pedestrian approaching the crossing's mouth.

FIG. 3 is block diagram of connection of individual elements of the system.

FIG. 4 shows an example of projected images without depiction of horizontal traffic signs, that is, without white strips of the crosswalk. Black color inversely depicts the illuminated surface, whereby this can have different color; the white surfaces are not illuminated.

FIG. 5 shows another example of projected images without depiction of horizontal traffic signs, that is, without white strips of the crosswalk. Black color inversely depicts the illuminated surface, whereby this can have different color; the white surfaces are not illuminated.

FIG. 6 shows another example of projected images without depiction of horizontal traffic signs, that is, without white strips of the crosswalk. Black color inversely depicts the illuminated surface, whereby this can have different color; the white surfaces are not illuminated.

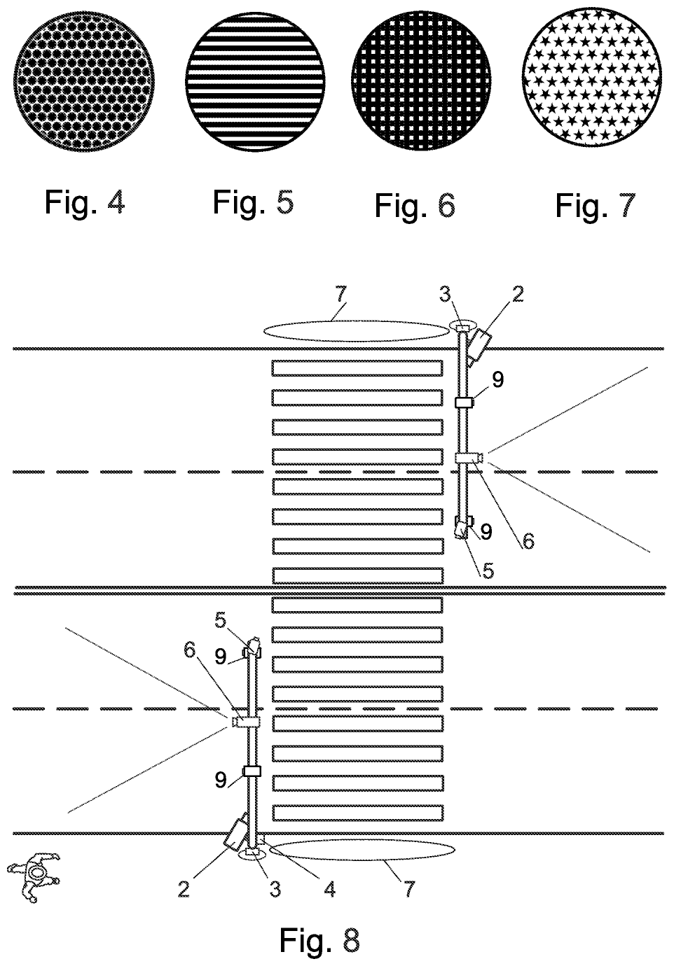

FIG. 4 shows another example of projected images without depiction of horizontal traffic signs, that is, without white strips of the crosswalk. Black color inversely depicts the illuminated surface, whereby this can have different color; the white surfaces are not illuminated.

FIG. 8 is a ground plan view of the system including two light projectors and a complex sensing of the values from the environment.

FIG. 9 is a block diagram of this system.

FIG. 10 shows a pedestrian on the crossing with the projection of images. Spatial view shows the example of projection of the image on the body of the pedestrian whereby on both examples the projection of the image on the body of the pedestrian is, for the sake of greater transparency, simplified, without shades on the road with a group of circles.

FIG. 11 shows a pedestrian on the crossing with the projection of images. Spatial view shows the example of projection of the image on the body of the pedestrian whereby on both examples the projection of the image on the body of the pedestrian is, for the sake of greater transparency, simplified, without shades on the road with a group of strips.

FIG. 12 depicts the decreased intensity of the lighting in the moment when the windshield of the vehicle is in the light field on the pedestrian crosswalk.

### EXAMPLES OF REALIZATION

### Example 1

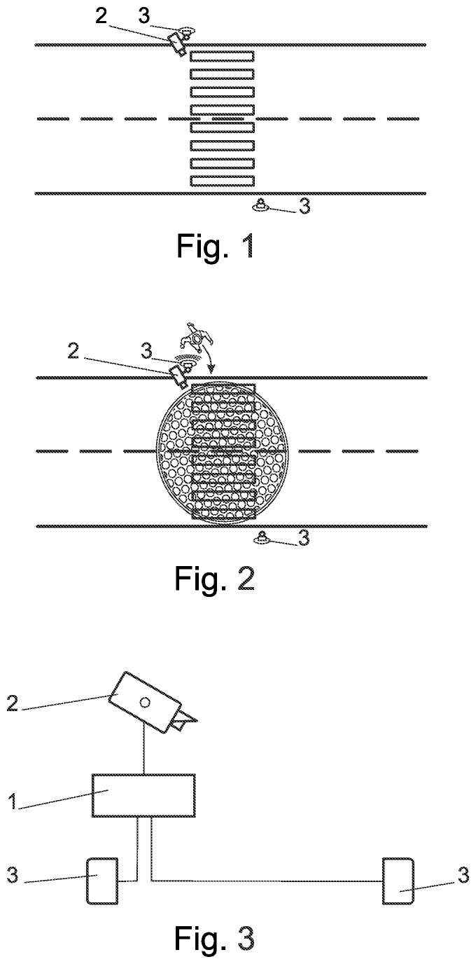

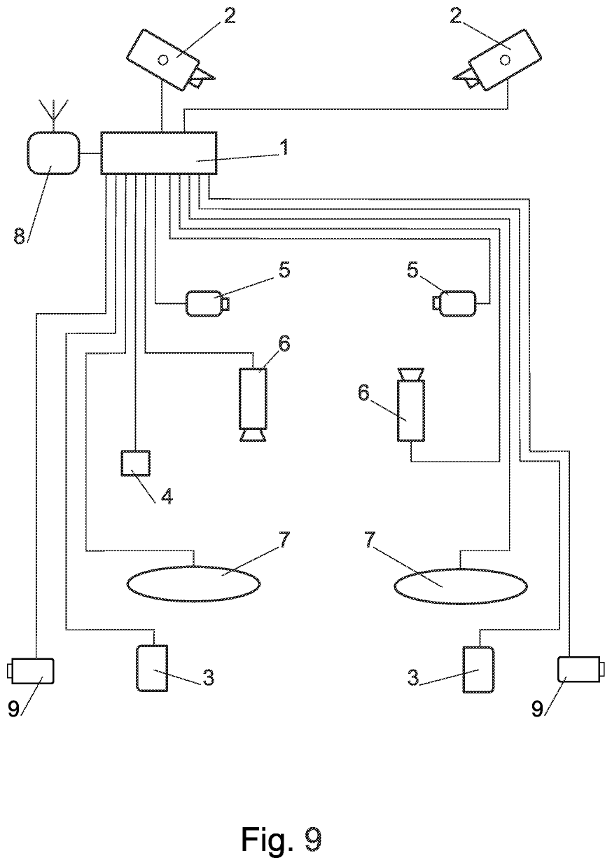

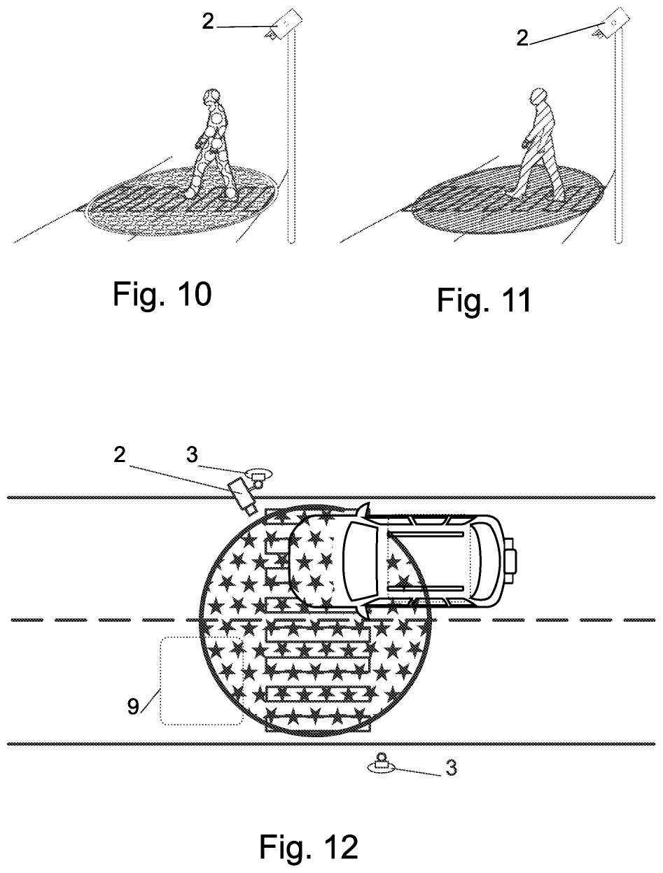

In this example pursuant to FIGS. 1 to 11 a system is implemented in a simple version. The control unit 1 is placed in the distributor of the public lighting. The light projector 2 is attached on the pole in the height of more than 5 meters which ensures the suitable angle of lighting of the surface of the crossing by a single light projector 2. The light projector 2 is controlled by the control unit 1. Two sensors 3 of the presence of the persons are connected to the control unit 1 and placed by the mouth of the crossing on both sides of the road. A sensor of the intensity of the visible light is connected to the control unit 1. Based on the data from this sensor the system activates itself during dawn pursuant to actual light conditions. A calendar of the sunset and sunrise for the given latitude is also stored in the control unit 1 so that the sensor of the intensity of the visible light can be corrected by the expected state of light and dark during the day.

After receiving the data concerning the presence of the persons from the sensor 3, the control unit 1 issues and instruction to the light projector 2 which includes the selection of the projected graphics, the color of the graphics, the intensity of the lighting, and so on. The light projector 2 projects the image onto the surface of the crossing pursuant to the instruction, whereby the person moving through the crossing is lighted by a bright color light and the sharp boundaries between the graphic elements in the image are projected onto the body and clothing of the person on the crosswalk. The movement of the person leads to movable overlapping of graphical elements in the image, which produces an emphatic visual impression. The driver on the road sees not only flat image on the surface of the crosswalk, but mainly the spatial interplay of the light on the body and clothing of the moving pedestrian.

In this example the crosswalk is after dark illuminated by the image consisting from dashed white strips oriented in parallel with the white strips which form the horizontal traffic sign (“the zebra”) delimiting the surface of the crosswalk. This graphic (FIG. 3) emphasizes the white strips, especially in case the color of the white strips include reflex components.

After the pedestrian enters the zone of detection of the sensor 3 of the presence of persons, the projected graphic changes into the group of light circles. The circles have clear, contrast boundaries and during the movement of the persons the projection of these boundaries onto the body and clothing of the person is changing.

### Example 2

In this example according to FIGS. 4 to 12 the system is applied in more complex realization with advanced recognition of various interactions between pedestrians and vehicles on the crosswalk and in its vicinity.

Taking into account the width of the road (and the crosswalk, therefore) there are two light projectors 2 used in this example; both are connected with the control unit 1 placed in an independent distribution box covered against weather conditions.

Sensors 3 of the presence of the persons are connected to the control unit 1 and these are distributed by the mouth of the crosswalk on both sides of the road, whereby the sensors 3 of the presence of the persons recognize the direction where the pedestrians approach the mouth of the crosswalk from. A sensor of the intensity of the visible light is connected to the control unit 1, as are multiple sensors 4 of the physical values of the environment, two speed sensors 6 in form of radars for determining the speed of the approaching vehicles, and sensors 7 of the physiological values of the persons, too. Sensors 9 of the vehicles are connected to the control unit 1, too. Signal from these sensors 9 is used for temporary diminishing of the intensity of the lighting in part of the projected field.

Control unit 1 in this example is equipped by the communication module 8 and is attached to the Internet network. The communication module 8 has Ethernet connector, WiFi, as well as GSM/5G. Control unit 1 allows for connection through web interface by means of GSM/GPRS or Ethernet.

Control unit 1 archives data concerning all measured data from the sensors in raw format as well as processed data concerning statuses and decisions for a given period of time, and these data can be approached through graphic web interface.

Following sensors are used as sensors 4 of the physical values of the environment in this example:
visible light spectrum sensor (the data are used to assess visibility),
temperature sensor and/or humidity sensor and/or air pressure sensor, dew point sensor (the data from these sensors are used to assess the weather and the risks associated with the expected braking distance of the vehicle),
air flow speed sensor (the data are used to predict the behavior of people in bad weather),
acoustic sensor, noise level sensor (the data are used to evaluate the behavior of people near the crosswalk, to assess the risks of behavior of people under the influence of addictive substances),
pollution sensor, sensor of the amount of solid and/or dust particles in the air in the environment, sensor of the composition of gases CO2, CO, NO2, H2S, formaldehyde, SO2, O3, NO and others, sensor of the concentration of volatile organic compounds (VOC), e.g. isobutane, butane, alcohol (data from these sensors help to predict pedestrians' behavior),
sensor of the intensity of the invisible spectrum, such as UV radiation, infrared light (the data are used to select the appropriate graphics and their colors).

Two radars directed towards the approaching vehicles from both directions are used as speed sensors 6.

In this example the system includes a camera 5, too, which is connected to the unit of processing and analysis of the image and this unit is connected to the control unit 1.

A contactless sensor of the heartbeat of the persons on the crosswalk and near the crosswalk is used as sensor 7 of the physiological values of the persons.

Control unit 1 contains a software which processes the measured data and pursuant to the programmed algorithm it controls both light projectors 2. For example, in case that control unit 1 determines, the data from the speed sensor 6, that there is a risk of collision with the pedestrian, the color of the projected image is changed to red and the pedestrian as well as the driver are alerted by this color to the looming collision.

The system is build as an open structure with free buses for later improvements and extensions.

### Example 3

Aside from the features mentioned in the previous examples, the arrangement in this example is characterized by the fact that in the common box of the light projector 2 there are further elements of the system, mainly a control unit 1. Pursuant to the level of integration there can be other features in the common box with the light projector, such as sensor 3 of the presence of the persons, the sensor 4 of the physical values of the environment, the camera 5, the vehicle speed sensor 6, the sensor 7 of the physiological values, the communication module 8.

### Example 4

Arrangement in this example pursuant to FIG. 12 diminishes the intensity of lighting in part of the projected field, in particular in the zone where the front windshield of the vehicle is actually present. Sensors 9 are used for the determination of the presence of the vehicle.

### INDUSTRIAL APPLICABILITY

Industrial applicability is obvious. According to this invention it is possible to industrially and repeatedly assemble and use system of lighting of the road crossings, mainly pedestrian crosswalks, and all this mainly to increase the safety of the traffic participants.

### LIST OF SYMBOLS

1—control unit
2—light projector
3—sensor of the presence of the persons
4—sensor of the physical value(s) of the environment
5—camera
6—vehicle speed sensor
7—sensor of physiological values
8—communication module
9—sensor of vehicles

1. A system of lighting of road crossings, mainly pedestrian crosswalks, the system comprising:
at least one lighting body and sensors (3) for detecting a presence of persons on both sides of the road crossing,
sensors (9) of vehicles approaching the road crossing, wherein the sensors (3) of the presence of the persons and the sensors (9) of the vehicles (9) are connected with a control of the lighting body, is characterized by the fact, that
wherein each one of the lighting body is formed by a light projector (2) whose light field is directed onto the road crossing,
wherein the light projector (2) is designed for a projection of various images onto the persons and the vehicles in a place of the road crossing,
wherein the light projector (2) is equipped by a device for a decreasing of an intensity of an illumination of at least part of an illuminated surface where the vehicle is present, ad
wherein the light projector (2) is connected to a control unit (1) for a control of the lighting and for the control of the decreasing of the intensity of the illumination in the place of the vehicle.

2. The system according to the claim 1, wherein the light projector (2) is equipped by multiple optical templates and/or optical filters for a choice of color and/or for the choice of the projected image, wherein the chosen optical templates and/or optical filters are inserted into a light flow at an output or before an output from the light projector (2); wherein the light projector (2) is equipped by shading dampers and/or filters.

3. The system according to the claim 1, wherein the light projector (2) is a video projector with a data input for the control of the image.

4. The system according to claim 1, wherein the image of the light projector (2) includes graphical elements having circles, polygons, strips, squares, rectangles, and/or combinations thereof,
wherein the graphical elements are separated by a surface of different color or different intensity of lighting, the graphical elements are repeated within the single image.

5. The system according to claim 1, wherein the image of the light projector (2) includes writings and/or pictograms.

6. The system according to claim 1, further comprising at least one sensor (4) of physical value of an environment connected with the control unit (1).

7. The system according to claim 6, wherein the sensor (4) of the physical value of the environment is selected from the group consisting of: a visible light spectrum sensor and/or a temperature sensor and/or a humidity sensor and/or an air pressure sensor, an air flow speed sensor, a dew point sensor, an acoustic sensor, a noise level sensor, a pollution sensor, or a sensor of the amount of solid and/or dust particles in an air in the environment, respectively, a gases composition sensor, a volatile organic compounds concentration sensor, an invisible spectrum intensity sensor, a UV radiation intensity sensor, an infrared sensor, and a magnetic field sensor

8. The system according to claim 1, further comprising at least one sensor (6) of a speed of the vehicle in a vicinity of the road crossing, whereby the vehicle speed sensor (6) is connected to the control unit (1).

9. The system according to claim 1, further including at least one sensor (7) of physiological values of the persons in the vicinity of the road crossing, whereby the sensor (7) of the physiological values of the persons is connected to the control unit (1).

10. The system according to claim 1, further comprising at least one camera (5) whose output is connected to the control unit (1) or whose output is connected to an image data analysis unit, and the image data analysis unit is connected to the control unit (1).

11. The system according to claim 1, further including a speaker connected to the control unit.

12. The system according to claim 1, wherein the central control unit (1) is equipped by a communication module (8), preferably with a connection to Internet and its own IP address.

13. The system according to the claim 12, further comprising a communication route of the communication module (8) formed by weak current cables.

14. The system according to the claim 13, wherein the weak current cables have DALI bus and a router for connection with different protocols.

15. The system according to the claim 12, wherein the communication route is formed by a wireless communication or PLC modules.

16. The system according to claim 1, wherein the control unit (1) has a memory for a storage of the sensed values and recognized statuses.

17. The system according to claim 1, wherein the control unit's (1) body is shaped as a multiple module of a circuit breaker with an attachment element onto a DIN rail.

18. The system according to claim 1, wherein the control unit (1) is equipped by a contactless communication channel for a connection with traffic participants.

19. A method of a lighting of road crossings, mainly pedestrian crosswalks, the method comprising the steps of:
detecting a presence of a person at least on some side of the road crossing and
illuminating the road crossing,
wherein the road crossing is illuminated by a light projector (2), at the same time an approach of a vehicle to the road crossing is detected and subsequently an intensity of the lighting of the road crossing by the light projector (2) is diminished at least on part of a surface of the road crossing where the vehicle is present.

20. The method according to claim 19, wherein the intensity of the lighting is diminished on the surface which corresponds to an actual position of a windshield of the vehicle and/or the actual position of a head of a driver of the vehicle.
